(19) United States
(12) Patent Application Publication
(10) Pub. No.: US 2008/0308218 A1
(43) Pub. Date: Dec. 18, 2008

(54) Method and Device for Producing Winding Liner with Spacer for Unvulcanized Strip Rubber Member, and Method and Device for Producing Spacer Member for Winding

(75) Inventors: Shinji Kashima, Kanagawa-ken (JP); Makoto Imai, Kanagawa-ken (JP); Arata Murakami, Kanagawa-ken (JP)

Correspondence Address: GREER, BURNS & CRAIN, 300 S WACKER DR, 25TH FLOOR, CHICAGO, IL, 60606, US

(73) Assignee: THE YOKOHAMA RUBBER CO., LTD., Tokyo (JP)

(21) Appl. No.: 12/161,499

(22) PCT Filed: Feb. 13, 2007
(86) PCT No.: PCT/JP2007/052495

§ 371 Date: Jul. 18, 2008

(30) Foreign Application Priority Data
Feb. 15, 2006 (JP) 2006-037763

(51) Int. Cl. B32B 38/00; B32B 38/18

(52) U.S. Cl. 156/244.11; 156/459

(57) ABSTRACT

Provided is a method and device for producing, efficiently with high productivity, a winding liner with a spacer for an unvulcanized strip rubber member as well as a method and device for producing a spacer member for the winding liner. A plate-shaped strip material (RW) is unwound from a material unwinding roll (16), then caused to pass between forming gears (19a and 19b) of a forming device (19) so as to be continuously formed in a shape of protrusions and recesses. An adhesive member (14) is attached to a surface of each of the strip spacer members (12a and 12b) each formed in the shape of protrusions and recesses. Then, the adhesive surfaces of the respective spacer members (12a and 12b) are continuously stuck along the longitudinal side edge portions of a plate-shaped base member (11) unwound from an unwinding device (45).

### TECHNICAL FIELD

The present invention relates to a method and device for producing a winding liner with a spacer for an unvulcanized strip rubber member, as well as to a method and device for producing a spacer member for the winding liner. More specifically, the present invention relates to a method and device for producing a winding liner with a spacer for an unvulcanized strip rubber member, which winding liner is capable of retaining and storing an unvulcanized strip rubber member, such as tread and side rubber members for a tire, without deformation thereof, by winding the unvulcanized strip rubber member in a coil form, while it is necessary for the unvulcanized strip rubber member to keep a certain extruded shape until the building. In addition, the present invention relates to a method and device for producing a spacer member for the winding liner.

### BACKGROUND ART

Conventionally, in a process or the like for building a tire, the following method is employed, as shown in FIG. 12. Firstly, an unvulcanized strip rubber member W including tire components, such as a tire tread and a side rubber member, is extruded and formed with a given shape or pattern by an extruder 1. The extruded unvulcanized strip rubber member is then cut at a certain length by a cutting machine 2. Thereafter, unvulcanized strip rubber members Wa each having been cut at the certain length are stacked in multiple stages on a carriage 3, such as a booker, so as to be stored therein for the purpose of keeping the shape of the members Wa until the building of a tire.

However, the unvulcanized strip rubber members Wa, such as tread and side rubber members for a tire, each of which is cut in the unvulcanized state at the certain length, are left untouched until the members Wa are used thereafter for the building of a tire. During this time, the contour and dimensions of the unvulcanized strip rubber members Wa are contracted as being cooled down. For this reason, the precision in dimension of the materials are made non-uniform at the time of the building of a tire. As a result, a problem is caused that the tire uniformity is deteriorated after the building of the tire.

In this respect, in recent years, the following approach has been adopted as shown in FIG. 13. Specifically, the unvulcanized strip rubber member W extruded and formed with a given shape or pattern by the extruder 1 is not cut at a certain length in advance, but is wound along with a winding liner R in a roll form with the long length. Then, the unvulcanized strip rubber member W is unwound to be cut at a certain length immediately before being used for the building. In this manner, the contraction of the contour and dimensions of the material is prevented, so that the precision in dimension is secured (for example, refer to Patent Document 1).

A conventional winding liner is formed of a non-stretchable strip mount and spacer portions each with a solid core. The non-stretchable strip mount is made of a resin, and has a lateral width not less than, at least, the width of an unvulcanized strip rubber member. Each of the spacer portions is formed of a rubber material in a shape of protrusions and recesses with a height not less than, at least, the thickness of the unvulcanized strip rubber member, and is stuck to each of both side edge portions, in the width direction, of a surface of the mount. The unvulcanized strip rubber member is wound in a roll form to be stored while being placed between the spacer portions each with the solid core. However, there is a problem that the winding liner and the unvulcanized strip rubber member tend to hang down due to their own weights. For this reason, a problem arises that the shape of the unvulcanized strip rubber member thus formed is squashed or deformed.

Furthermore, since the spacer portions each made of a rubber material with the solid core are fixed respectively to both of the side edge portions, in the width direction, of the surface of the mount, the winding liner has poor stretchability in the longitudinal direction, and also is heavy in weight. In addition, when the winding liner is bent in a roll form to be used, a large flexing resistance of each spacer portion causes problems that the shape of the rails is deformed, and that the winding liner is damaged to be incapable of being re-used. Moreover, since the spacer portions each with the solid core are used, even though the shape of the unvulcanized strip rubber member thus formed is kept, the ventilation of air between the inside and the outside of the spacer portions is poor. For this reason, there is a problem that heating and cooling efficiency is very poor when the unvulcanized strip rubber member is stored.

In view of the above-described circumstances, the inventors of the present invention applied a winding liner for an unvulcanized strip rubber member and a method for producing the winding liner (for example, refer to Patent Document 2). Specifically, this applied winding liner is reduced in weight, is capable of being repeatedly used without causing damage of a spacer member, and also is capable of enhancing heating and cooling efficiency at the time of storing an unvulcanized strip rubber member while keeping the shape of the unvulcanized strip rubber member.

However, the above application does not propose a method and device for producing a spacer member for a winding liner for an unvulcanized strip rubber member, and a method and device for continuously and efficiently producing a winding liner with a spacer.

Patent Document 1: Japanese Patent Application Kokai Publication No. Hei. 5-301300 (pp. 2 to 3, FIG. 1)
Patent Document 2: International Patent Kokai Publication No. WO2005/053941 A1 Pamphlet

### DISCLOSURE OF THE INVENTION

### Problems to be Solved by the Invention

The present invention has been made with a focus on the conventional problems. An object of the present invention is to provide a method and device for producing a winding liner with a spacer for an unvulcanized strip rubber member, as well as a method and device for producing a spacer member for the winding liner, which methods and devices are capable of efficiently and also continuously producing a winding liner with a spacer, and a spacer member for the winding liner.

### Means for Solving the Problems

For the purpose of achieving the above-described object, a method for producing a winding liner with a spacer for an unvulcanized strip rubber member of the present invention is characterized by including the steps of: causing a plate-shaped strip material to pass through a forming device to be continuously formed in a shape of protrusions and recesses, the plate-shaped strip material being unwound from a material unwinding roll; attaching an adhesive member to a surface of the strip spacer member thus formed in the shape of protrusions and recesses; and sticking the adhesive surface of the thus-formed spacer member to a plate-shaped base member along each side edge portion of the plate-shaped base member in the longitudinal direction.

In addition another method of producing a winding liner with a spacer for an unvulcanized strip rubber member of the present invention is characterized by including the steps of: causing a plate-shaped strip material to pass through a forming device to be continuously formed in a shape of protrusions and recesses, the plate-shaped strip material being unwound from a material unwinding roll; attaching an adhesive member to a surface of the strip spacer member thus formed in the shape of protrusions and recesses; and continuously sticking the adhesive surface of the thus-formed spacer member to a plate-shaped base member along each side edge portion of the plate-shaped base member in the longitudinal direction, the plate-shaped base member being unwound from an unwinding device.

Here, in the process of sticking the spacer member to the plate-shaped base member, an end portion of the spacer member with a predetermined length may be fixed by using a fastening member.

On the other hand, a device for producing a winding liner with a spacer for an unvulcanized strip rubber member of the present invention is characterized by including: a forming device that continuously forms a plate-shaped strip material in a shape of protrusions and recesses with a predetermined pitch, the plate-shaped strip material being unwound from a material unwinding roll; an adhesive-member attaching device that attaches an adhesive material to a surface of a strip spacer member formed by the forming device; a base-member unwinding device that sticks the adhesive surface of the spacer member with the adhesive member attached thereto to a plate-shaped base member along each of the side edge portions of the plate-shaped base member in the longitudinal direction; and a winding device for a winding liner in which the spacer member is stuck to the base member.

Another device for producing a winding liner with a spacer for an unvulcanized strip rubber member of the present invention is characterized by including: a forming device that continuously forms a plate-shaped strip material in a shape of protrusions and recesses with a predetermined pitch, the plate-shaped strip material being unwound from a material unwinding roll; an adhesive-member attaching device that attaches an adhesive material to a surface of a strip spacer member formed by the forming device; a base-member unwinding device that continuously sticks the adhesive surface of the spacer member with the adhesive member attached thereto to a plate-shaped base member along each of the side edge portions of the plate-shaped base member in the longitudinal direction, the plate-shaped base member being unwound from an unwinding roll; and a winding device for a winding liner in which the spacer member is stuck to the base member.

Here, fastening means for fixing an end portion of the strip spacer member to the base member may be disposed between the base-member unwinding device and the winding device for the winding liner. In addition, guide rollers for preventing the meandering of the material and failure in the loading of the material may be provided to each of the material unwinding roll and the winding device for the winding liner. Moreover, a brake device may be provided to a winding shaft of the winding device.

In addition, a method for producing a spacer member for a winding liner for an unvulcanized strip rubber member of the present invention is characterized by including the steps of: causing a plate-shaped strip material to pass through a forming device to be continuously formed in a shape of protrusions and recesses, the plate-shaped strip material being unwound from a material unwinding roll; and attaching an adhesive member to a surface of the strip spacer member thus formed in the shape of protrusions and recesses.

Moreover, a device for producing a spacer member for a winding liner for an unvulcanized strip rubber member of the present invention is characterized by including: a forming device which continuously forms a plate-shaped strip material in a shape of protrusions and recesses with a predetermined pitch, the plate-shaped strip material being unwound from a material unwinding roll; and an adhesive-member attaching device which attaches an adhesive member to a surface of a spacer member formed by the forming device.

Here, the forming device may be a pair of forming gears, each having concave and convex blades with a predetermined pitch, and being capable of rotationally driven. In addition, the adhesive member may be a double-sided adhesive tape.

Producing a winding liner with a spacer and a spacer member for the winding liner as described above makes it possible to produce the winding liner and the spacer member continuously and also efficiently at a low cost. In addition, producing individually the spacer members for the winding liner allows the winding liner to be employed for various tire components.

### EFFECTS OF THE INVENTION

The present invention, which is configured as described above, provides the following excellent effects.

(a) The winding liner can be employed for various tire components with various sizes and thicknesses by individually producing a spacer member for a winding liner, and attaching for use to a base member in accordance with its application.

(b) The spacer member for the winding liner can be continuously and also efficiently produced.

(c) The spacer member can be produced with simple devices.

(d) The spacer member for the winding liner can be continuously produced, and the winding liner can be produced by attaching the spacer member for the winding liner to the base member with the adhesive member. Accordingly, the winding liner with a spacer can be effectively produced.

(e) The spacer member for the winding liner can be continuously produced. In addition, the winding liner can be produced by attaching the adhesive member to the spacer member for the winding liner, and also by sticking the spacer member to the base member unwound from the unwinding device. Accordingly, the winding liner with a spacer can be effectively produced.

(f) The winding liner with a spacer can be effectively produced. In addition, the winding liner with a spacer can be wound by, and unwound from, the winding device, in an aligned state with no meandering of the winding liner.

(g) The entire device for producing the winding liner with a spacer can be simply manufactured at a low cost.

(h) Using the spacer member formed of a plate-shaped material with the shape of protrusions and recesses makes it possible to reduce the weight of the winding liner. In addition, a favorable ventilation of air between the inside and the outside of the spacer members makes it possible to enhance the heating and cooling efficiency when the unvulcanized strip rubber member is stored while keeping the shape of the unvulcanized strip rubber member. As a result, assurance of the product quality can be secured.

### BRIEF DESCRIPTION OF THE DRAWINGS

FIG. 1 is a perspective view showing a state an unvulcanized strip rubber member is being wound by using a winding liner with a spacer of the present invention.

FIG. 2 is an enlarged cross-sectional view taken along the line X-X and viewed in the direction of the arrow X in FIG. 1.

FIG. 3 is a schematic explanatory view of a process for producing a spacer member having concave and convex parts.

FIG. 4 is an enlarged front view of the A part in FIG. 3.

FIG. 5 is a side view of FIG. 4.

FIG. 6 is an enlarged front view of the B part in FIG. 3.

FIG. 7 is an enlarged front view of the C part in FIG. 3.

FIG. 8 is a side view of FIG. 7.

FIG. 9 is an explanatory view of a process for continuously producing the winding liner by sticking the spacer member to a base member while the spacer member is continuously produced.

FIG. 10 is an enlarged front view of the D part in FIG. 9.

FIG. 11 is a side view of FIG. 10.

FIG. 12 is an explanatory view of a conventional method of storing an unvulcanized strip rubber member on a carriage.

FIG. 13 is an explanatory view of a conventional method of storing an unvulcanized strip rubber member by winding the member in a roll form with a liner.

### Explanation of the Reference Numerals

11 BASE MEMBER
12a, 12b SPACER MEMBER
13 CONCAVE AND CONVEX PART
14 ADHESIVE MEMBER
16 MATERIAL UNWINDING ROLL
17a, 17b GUIDE ROLL
18 GUIDE MEMBER
19 FORMING DEVICE
19a, 19b FORMING GEAR
20 ADHESIVE MEMBER ATTACHING DEVICE
23 BAND BRAKE
24 MANUAL HANDLE
26 GUIDE ROLLER
29 TRANSFER ROLL
30 ATTACHING DEVICE
31 DOUBLE-SIDED TAPE UNWINDING ROLL
32 DOUBLE-SIDED TAPE
33 PRESS-FITTING ROLL
34 RELEASED PAPER
35 PAPER UNWINDING ROLL
36 LINER WINDING DEVICE
41 BAND BRAKE
42 MANUAL HANDLE
44a, 44b GUIDE GEAR
45 UNWINDING DEVICE
46 FASTENING MEANS
47 WINDING ROLL
W, Wa UNVULCANIZED STRIP RUBBER MEMBER
R WINDING LINER
α INCLINATION ANGLE
Rw STRIP MATERIAL

### BEST MODES FOR CARRYING OUT THE INVENTION

Hereinafter, embodiments of the present invention will be described with reference to the accompanying drawings. Note that, in the following descriptions, the same constituent elements as those of a conventional example are denoted by the same reference numerals, and are not described.

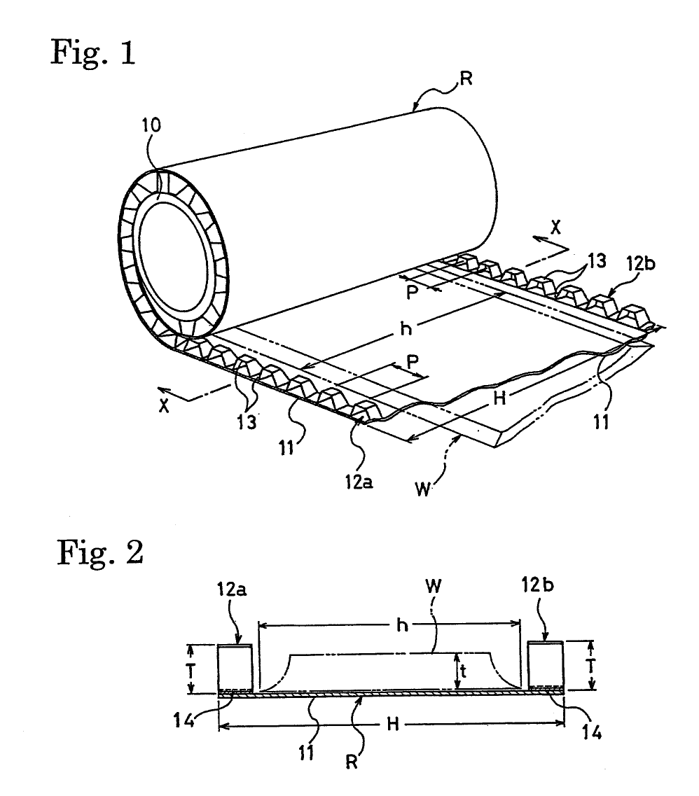

FIG. 1 is a perspective view showing a state where an unvulcanized strip rubber member W is being wound around a core 10 with a winding liner R, and where the present invention is implemented. The winding liner R according to the present invention includes a plate-shaped strip base member 11 and strip spacer members 12a and 12b. The base member 11 is formed of a plate made of an aluminum alloy (such as, alloys of JIS A3000 series, A5000 series, and A6000 series). The spacer members 12a and 12b are stuck respectively to both side edge portions, in the width direction, of a surface of the base member 11, and each are formed in a shape of protrusions and recesses.

Specifically, the base member 11 is obtained by anodizing a surface of a plate made of an aluminum alloy (JIS A5052P) with a thickness of 0.6 mm to 1.0 mm. The base member 11 has a lateral width H which is larger than, at least, the width h of the unvulcanized strip rubber member W to be wound and stored.

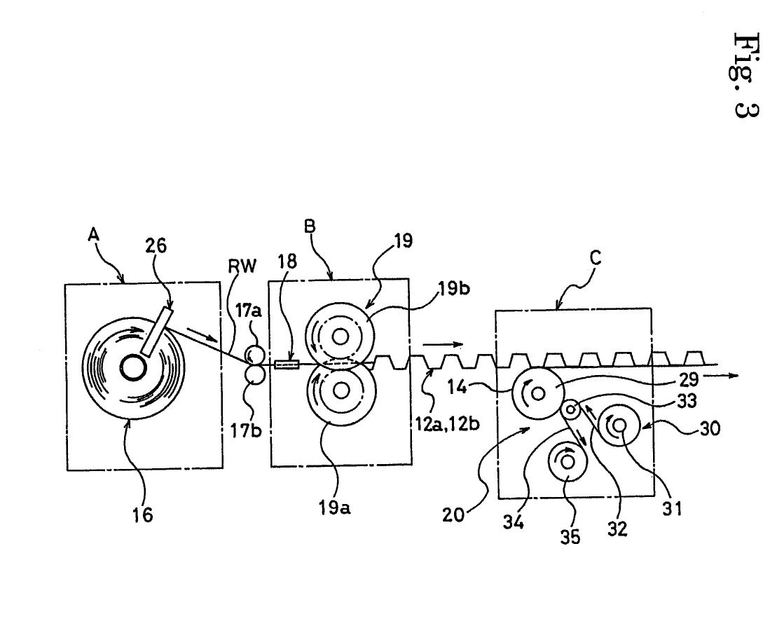

Meanwhile, the strip spacer members 12a and 12b each formed in the shape of protrusions and recesses are formed in the following manner. Each of the strip spacer members 12a and 12b is formed of a narrow plate made of an aluminum alloy (JIS A5052P) with a thickness of 0.5 mm to 0.8 mm, as shown in FIG. 2. In addition, concave and convex parts 13 are formed at a predetermined pitch P along the longitudinal direction on each of the strip spacer members 12a and 12b. Each of the concave and convex parts 13 is formed in a substantially trapezoidal shape in its cross section to have stretchability in the longitudinal direction. These strip spacer members 12a and 12b thus formed are stuck, in parallel with each other, along the longitudinal direction, on both side edge portions, in the width direction, of the surface of the base member 11 with adhesive members 14 (although a double-sided tape is used in this embodiment, the adhesive member 14 is not limited to the double-sided tape, and a general adhesive agent can alternatively be used as well).

In other words, each concave and convex part 13 has a height T that is larger than, at least, the thickness t of the unvulcanized strip rubber member W. The width, the height T, and the pitch P are set appropriately in accordance with the size of the substantially trapezoidal shape in the cross section of the unvulcanized strip rubber member W to be stored.

The following methods may be employed as a method for producing the winding liner R as described above. In one method, the base member 11 and the strip spacer members 12a and 12b, each formed in the shape of protrusions and recesses, are firstly produced separately. These members are then assembled with the adhesive member 14, so that the winding liner R is formed. In another method, the strip spacer members 12a and 12b are continuously produced. Then, these spacer members 12a and 12b are stuck to the base member 11 with the adhesive member 14, so that the winding liner R is continuously produced.

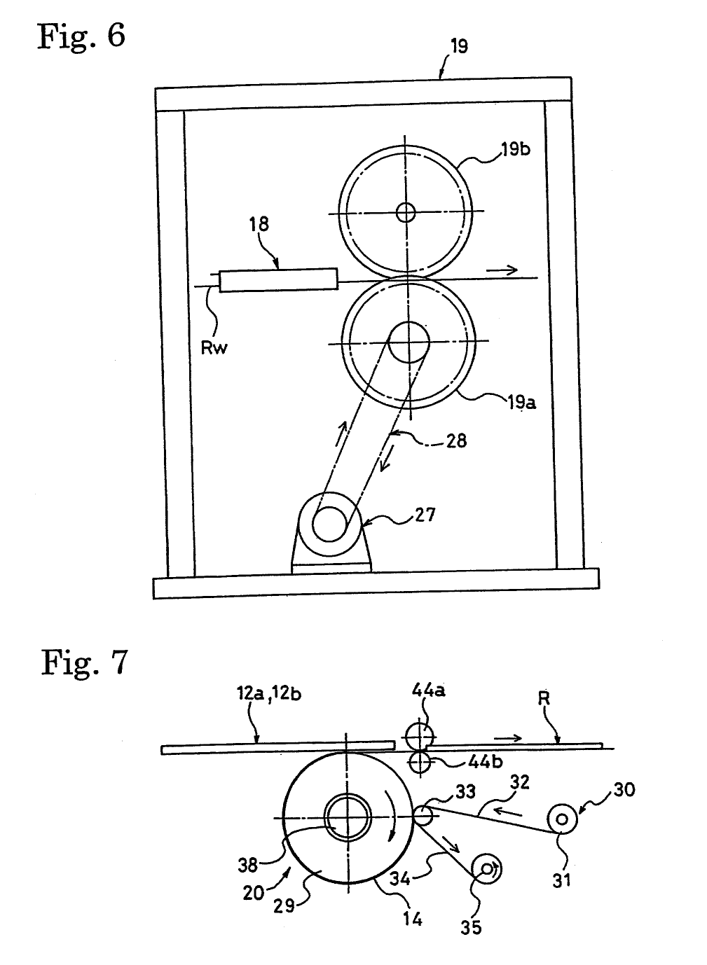

The strip spacer members 12a and 12b are produced individually in the following manner. Firstly, as shown in FIGS. 3 to 5, a plate-shaped strip material Rw is unwound from a material unwinding roll 16, which is installed on a support table 15 to be capable of being rotationally driven. The strip material Rw thus unwound is caused to pass between guide rolls 17a and 17b, and then through a guide member 18. The strip material Rw is then caused to pass between a pair of forming gears 19a and 19b of a forming device 19, which is shown in FIG. 6 so as to be continuously formed in the shape of protrusions and recesses. Then, by using an adhesive-member attaching device 20, the adhesive member 14 is attached to a surface of the strip spacer member 12a or 12b thus formed in the shape of protrusions and recesses.

It should be noted that, in the above descriptions, described is a method including causing a single plate-shaped strip material Rw unwound from the material unwinding roll 16 to pass between the pair of forming gears 19a and 19b of the forming device 19 to be continuously formed in the shape of protrusions and recesses. Alternatively, it is also possible that multiple forming device 19 are placed in parallel with each other, and that multiple plate-shaped strip materials Rw are simultaneously formed each in the shape of protrusions and recesses.

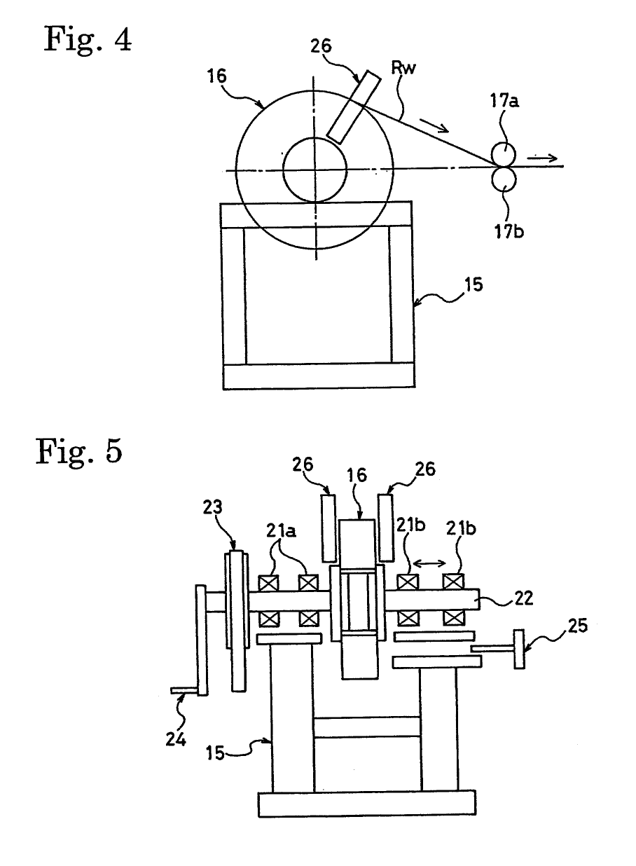

The material unwinding roll 16 installed on the support table 15 to be capable of being rotationally driven has a roll shaft 22 rotatably supported on bearing members 21a and 21b provided on the support table 15, as shown in FIGS. 4 and 5. A band brake 23 and a manual handle 24 are rotatably supported on one end side of the roll shaft 22. A moving handle 25 for moving the roll shaft 22 in the longitudinal direction of the roll shaft 22 with the bearing members 21b in between is provided on the other end side of the roll shaft 22.

In addition, meandering-preventing guide rollers 26 extending in the radial direction of the material unwinding roll are disposed on the sides of the material unwinding roll 16. The guide rollers 26 are disposed for preventing the plate-shaped strip material Rw from meandering when being unwound.

Next, the forming device 19 shown in FIG. 6 includes the pair of forming gears 19a and 19b, which is rotationally driven, and each of which has concave and convex blades with a predetermined pitch. This forming gear 19a is configured to be rotationally driven at a predetermined speed by a driving motor 27 with drive transmitting means 28, such as a chain or a belt.

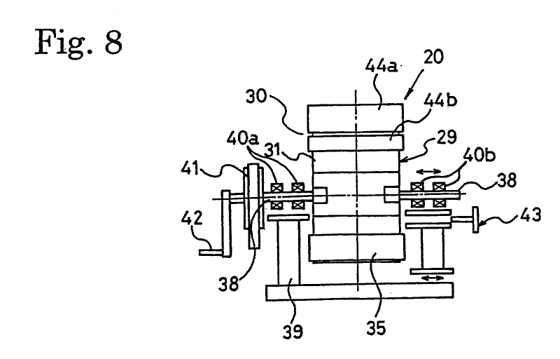

The adhesive agent attaching device 20 includes a transfer roll 29 and an attaching device 30 as shown in FIG. 7 and FIG. 8. The transfer roll 29 transfers the adhesive member 14 onto one surface of the spacer member 12a or 12b. The attaching device 30 attaches the adhesive member 14 to the surface of the transfer roll 29. The attaching device 30 is configured to press-fit, with a press-fitting roll 33, a surface having an adhesive agent applied thereto of a double-sided tape 32 which is unwound from a double-sided tape unwinding roll 31, and to transfer the adhesive member 14 to an outer circumferential surface of the transfer roll 29, while a released paper 34 of the double-sided tape 32 is wound by a paper winding roll 35.

The spacer member 12a or 12b to which the adhesive member 14 is applied is caused to pass between guide gears 44a and 44b to be transported to a next process, such as a liner winding device 36. In addition, a roll shaft 38 of the transfer roll 29 is installed on a support table 39 with bearing members 40a and 40b in between to be capable of being rotationally driven as shown in FIG. 8. A band brake 41 and a manual handle 42 are provided on one end side of the material unwinding roll 30. On the other hand, a moving handle 43 for moving the roll shaft 38 in the longitudinal direction of the roll shaft 38 with the bearing members 30b in between is provided on the other end side of the roll shaft 38.

In the above-described manner, the spacer members 12a and 12b each having a predetermined length and a predetermined size are produced in advance. Then, the winding liner R is produced by sticking these spacer members 12a and 12b respectively on both side edge portions, in the width direction, of the surface of the base member 11 with the adhesive member 14 in between. Meanwhile, each of the spacer members 12a and 12b having the predetermined length is stuck to the surface of the base member 11 while being fastened, at an end portion thereof, to the base member 11 with a fastening member, such as a rivet.

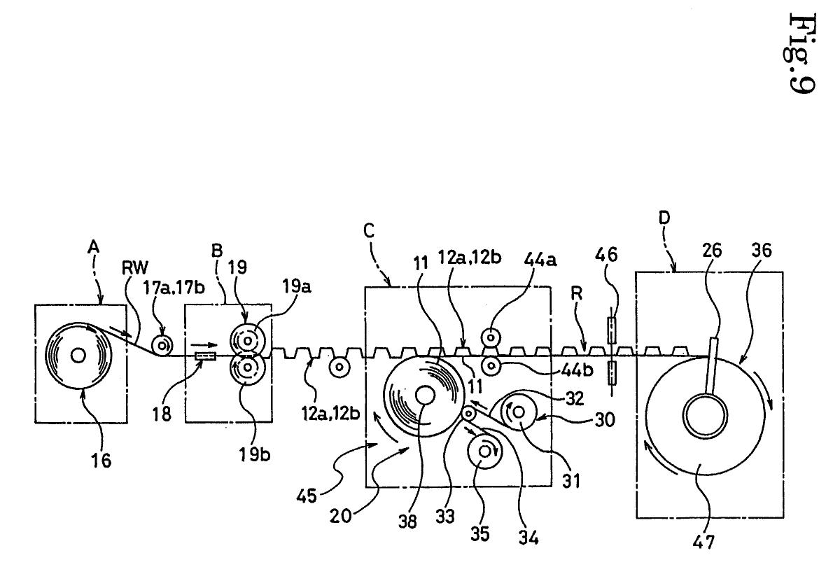

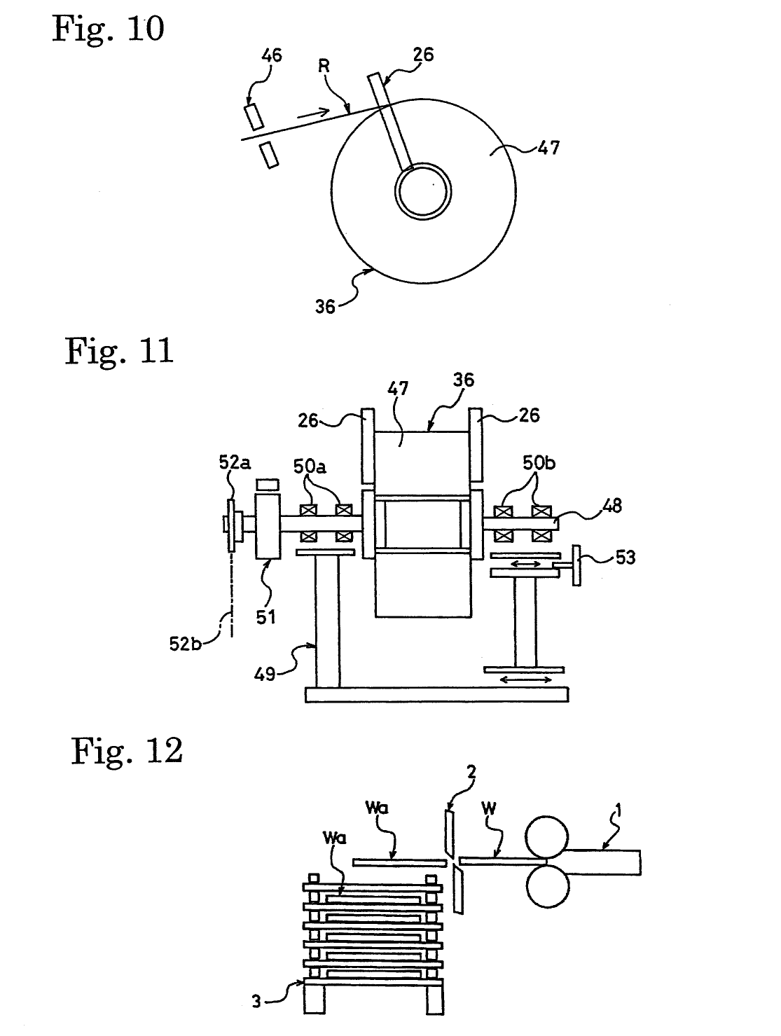

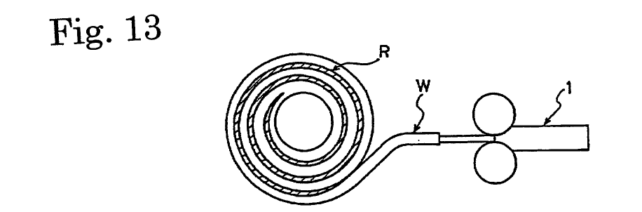

Next, described is the producing method in which the spacer members 12a and 12b are continuously stuck to the base member 11 with the adhesive member 14. Specifically, as shown in FIG. 9 to FIG. 11, the plate-shaped strip material Rw is unwound from the material unwinding roll 16 installed on the support table 15 to be capable of being rotationally driven. The strip material Rw thus unwound is caused to pass through the forming device 19 through the guide rolls 17a and 17b, as well as the guide member 18 so as to be continuously formed in the shape of protrusions and recesses. Then, by using the adhesive-member attaching device 20, the adhesive member 14 is attached to a surface of the strip spacer member 12a or 12b thus formed in the shape of protrusions and recesses.

In this event, the surface (adhesive surface) with the adhesive member 14 attached thereto of the strip spacer member 12a or 12b is continuously stuck to the plate-shaped base member 11 unwound from an unwinding device 45 along a side edge portion of the base member 11 in the longitudinal direction. Then, the base member 11 having the spacer members 12a and 12b attached thereto is caused to pass between the guide gears 44a and 44b to be transported toward the liner winding device 36. Then, the base member 11 with the spacer members 12a and 12b is wound by the liner winding device 36 while each of the spacer members 12a and 12b is fastened and fixed, at an end portion thereof, to the base member 11 by using fastening means 46, such as a rivet.

Note that, in the liner winding device 36, a roll shaft 48 of a winding roll 47 is installed with bearing members 50a and 50b provided on a support table 49 so as to be capable of being rotationally driven. A ratchet 51 and a sprocket 52a are provided on one end side of the roll shaft 48. The roller shaft 48 is then connected to an unillustrated driving motor with a chain 52b. On the other hand, a moving handle 53 for moving the roll shaft 48 in the longitudinal direction of the roll shaft 48 with the bearing members 50b in between is provided on the other end side of the roll shaft 48.

In this embodiment, the spacer members 12a and 12b each having the predetermined size are continuously produced. At the same time, after being produced, the spacer members 12a and 12b are stuck respectively to the side edge portions, in the width direction, of the base member 11 with the adhesive member 14. Accordingly, the winding liner R can be continuously produced without the manpower. Moreover, the produced winding liner R with a predetermined length is wound in a roll shape on the winding roll 47 of the liner winding device 36 so as to be stored.

Note that, since other configuration and effects are the same as those of the above-described embodiment, descriptions thereof will be omitted with the same reference numerals given thereto. As described above, the base member 11 and the spacer members 12a and 12b each having the concave and convex parts 13 are formed of plates made of an aluminum alloy, and the winding liner R is produced by assembling these members. For this reason, the winding liner R can be produced easily at low costs, and also the weight of the entire winding liner R can be reduced. Moreover, each of the spacer members 12a and 12b is formed by processing a place into the shape of protrusions and recesses, and then is joined and fixed in the longitudinal direction by using the adhesive member 14, such as the double-sided tape, and the fastening means 46, such as the rivet. In this manner, each of the spacer members 12a and 12b can be stuck to be stretchable. For this reason, the winding liner R can be easily bent against low resistance when being wound.

1. A method for producing a winding liner with a spacer for an unvulcanized strip rubber member, comprising the steps of:
causing a plate-shaped strip material to pass through a forming device to be continuously formed in a shape of protrusions and recesses, the plate-shaped strip material being unwound from a material unwinding roll;
attaching an adhesive member to a surface of the strip spacer member thus formed in the shape of protrusions and recesses; and
sticking the adhesive surface of the thus-formed spacer member to a plate-shaped base member along each side edge portion of the plate-shaped base member in the longitudinal direction.

2. A method of producing a winding liner with a spacer for an unvulcanized strip rubber member, comprising the steps of:
causing a plate-shaped strip material to pass through a forming device to be continuously formed in a shape of protrusions and recesses, the plate-shaped strip material being unwound from a material unwinding roll;
attaching an adhesive member to a surface of the strip spacer member thus formed in the shape of protrusions and recesses; and
continuously sticking the adhesive surface of the thus-formed spacer member to a plate-shaped base member along each side edge portion of the plate-shaped base member in the longitudinal direction, the plate-shaped base member being unwound from an unwinding device.

3. The method of producing a winding liner with a spacer for an unvulcanized strip rubber member according to any one of claims 1 and 2, wherein
in the process of sticking the spacer member to the plate-shaped base member, an end portion of the spacer member with a predetermined length is fixed by using a fastening member.

4. A device for producing a winding liner with a spacer for an unvulcanized strip rubber member, comprising:
a forming device that continuously forms a plate-shaped strip material in a shape of protrusions and recesses with a predetermined pitch, the plate-shaped strip material being unwound from a material unwinding roll;
an adhesive-member attaching device that attaches an adhesive material to a surface of a strip spacer member formed by the forming device;
a base-member unwinding device that sticks the adhesive surface of the spacer member with the adhesive member attached thereto to a plate-shaped base member along each of the side edge portions of the plate-shaped base member in the longitudinal direction; and
a winding device for a winding liner in which the spacer member is stuck to the base member.

5. A device for producing a winding liner with a spacer for an unvulcanized strip rubber member, comprising:
a forming device that continuously forms a plate-shaped strip material in a shape of protrusions and recesses with a predetermined pitch, the plate-shaped strip material being unwound from a material unwinding roll;
an adhesive-member attaching device that attaches an adhesive material to a surface of a strip spacer member formed by the forming device;
a base-member unwinding device that continuously sticks the adhesive surface of the spacer member with the adhesive member attached thereto to a plate-shaped base member along each of the side edge portions of the plate-shaped base member in the longitudinal direction, the plate-shaped base member being unwound from an unwinding roll; and
a winding device for a winding liner in which the spacer member is stuck to the base member.

6. The device for producing a winding liner with a spacer for an unvulcanized strip rubber member according to any one of claims 4 and 5, further comprising fastening means for fixing an end portion of the strip spacer member to the base member, the fastening means being disposed between the base-member unwinding device and the winding device for the winding liner.

7. The device for producing a winding liner with a spacer for an unvulcanized strip rubber member according to any one of claims, further comprising guide rollers for preventing the meandering of the material and failure in the loading of the material, the guide rollers being provided to each of the material unwinding roll and the winding device for the winding liner.

8. The device for producing a winding liner with a spacer for an unvulcanized strip rubber member according to any one of claims, further comprising a brake device provided to a winding shaft of the winding device.

9. A method for producing a spacer member for a winding liner for an unvulcanized strip rubber member, comprising the steps of:
causing a plate-shaped strip material to pass through a forming device to be continuously formed in a shape of protrusions and recesses, the plate-shaped strip material being unwound from a material unwinding roll; and
attaching an adhesive member to a surface of the strip spacer member thus formed in the shape of protrusions and recesses.

10. A device for producing a spacer member for a winding liner for an unvulcanized strip rubber member, comprising:
a forming device which continuously forms a plate-shaped strip material in a shape of protrusions and recesses with a predetermined pitch, the plate-shaped strip material being unwound from a material unwinding roll; and
an adhesive-member attaching device which attaches an adhesive member to a surface of a spacer member formed by the forming device.

11. The device for producing a spacer member for a winding liner for an unvulcanized strip rubber member according to claim 10, wherein the forming device is a pair of forming gears, each having concave and convex blades with a predetermined pitch, and being capable of rotationally driven.

12. The device for producing a spacer member for a winding liner for an unvulcanized strip rubber member according to any one of claims 10 and 11, wherein the adhesive member is a double-sided adhesive tape.
